(19) United States
(12) Patent Application Publication
(10) Pub. No.: US 2018/0200892 A1
(43) Pub. Date: Jul. 19, 2018

(54) ROBOT

(71) Applicant: Seiko Epson Corporation, Tokyo (JP)

(72) Inventors: Yuji SHIMADA, Shen Zhen (CN); Naoki UMETSU, Mikawa (JP); Tsuguya KOJIMA, Chino (JP); Masato YOKOTA, Azumino (JP)

(21) Appl. No.: 15/862,981

(22) Filed: Jan. 5, 2018

(30) Foreign Application Priority Data
Jan. 19, 2017 (JP) 2017-007316

(51) Int. Cl. B25J 13/08; B25J 9/16; G05B 19/401; G01L 5/00

(52) U.S. Cl. CPC B25J 13/085; B25J 9/1694; B25J 9/1633; B25J 9/1651; Y10S 901/46; G01L 5/0061; G05B 2219/37357; G05B 2219/40606; Y10S 901/09; G05B 19/401

(57) ABSTRACT

A robot includes a robot arm having at least one arm, from which an end effector is detachable, a force detection unit provided between the end effector and the arm, and an energizing member that energizes the end effector toward the force detection unit side. It is preferable that the energizing member is an elastic member having elasticity. Further, a connecting part that couples the robot arm and the end effector is provided, and it is preferable that the force detection unit is provided between the end effector and the connecting part.

### BACKGROUND

### 1. Technical Field

The present invention relates to a robot.

### 2. Related Art

In related art, industrial robots including robot arms and end effectors attached to the distal ends of the robot arms are known (for example, Patent Document 1 (JP-A-2013-56402).

The robot described in Patent Document 1 includes a robot arm, a hand attached to the distal end of the robot arm, and a force measuring unit provided between the robot arm and the hand and measuring a force acting on the hand. The robot may measure the mass of a work grasped by the hand based on the force obtained by the force measuring unit and the mass of the hand.

However, in the measurement by the robot described in Patent Document 1, it is difficult to obtain the mass of the work with high accuracy because the mass of the hand is taken into consideration. Particularly, in the case where a load cell is used as the force measuring unit, for example, if the hand has rattles or the like, even when the hand comes into contact with the work, the load cell does not promptly react, but starts to react after the load of the hand on the work is applied to some extent. Accordingly, there is a problem of difficulty in detection of the contact between the hand and the work or the like with high accuracy.

### SUMMARY

An advantage of some aspects of the invention is to solve at least a part of the problems described above, and the invention can be implemented as the following configurations.

A robot according to an aspect of the invention includes a robot arm having at least one arm, from which an end effector is detachable, a force detection unit provided between the end effector and the arm, and an energizing member that energizes the end effector toward the force detection unit side.

According to the robot of the aspect of the invention, the energizing member that energizes the end effector toward the force detection unit side is provided, and thereby, rattles or the like of the end effector may be reduced. Accordingly, detection accuracy of contact of the end effector with an object or the like by the force detection unit may be improved.

In the robot according to the aspect of the invention, it is preferable that the energizing member is an elastic member having elasticity.

With this configuration, rattles or the like of the end effector may be reduced more effectively, and the detection accuracy by the force detection unit may be further improved.

In the robot according to the aspect of the invention, a connecting part that couples the robot arm and the end effector is provided, and it is preferable that the force detection unit is provided between the end effector and the connecting part.

With this configuration, detection accuracy of contact of the end effector with an object or the like by the force detection unit may be improved.

In the robot according to the aspect of the invention, it is preferable that the arm is rotatable, the end effector is rotatable about a rotation axis of the arm, and a plurality of the energizing members are provided around the rotation axis.

With this configuration, the end effector may be energized toward the force detection unit side with balance, and rattles or the like of the end effector may be reduced more effectively. Accordingly, the detection accuracy by the force detection unit may be further improved.

In the robot according to the aspect of the invention, it is preferable that the end effector has a first holding part and a second holding part that can hold an object.

With this configuration, for example, two objects may be grasped at a time by the end effector, and workability by the robot may be improved.

In the robot according to the aspect of the invention, it is preferable that the second holding part can move over a longer distance than the first holding part.

With this configuration, interferences between the object held by the first holding part and the object held by the second holding part may be reduced or avoided.

In the robot according to the aspect of the invention, it is preferable that the end effector has a base part, the first holding part is fixed to the base part, and the second holding part is movable with respect to the base part.

With this configuration, interferences between the object held by the first holding part and the object held by the second holding part may be reduced or avoided more effectively. Further, one of the two holding parts (the first holding part and the second holding part) is fixed, and moment applied to the end effector may be made smaller.

In the robot according to the aspect of the invention, it is preferable that the arm is rotatable, the end effector is rotatable about a rotation axis of the arm, the first holding part and the second holding part are respectively provided around the rotation axis, and letting a distance between a center of the first holding part and the rotation axis be D1 and a distance between a center of the second holding part and the rotation axis be D2, 0.9≤D1/D2≤1.1.

With this configuration, the moment applied to the end effector may be made smaller.

In the robot according to the aspect of the invention, it is preferable that the arm is rotatable, the end effector is rotatable about a rotation axis of the arm, and the first holding part and the second holding part are provided so that the rotation axis may be located between the first holding part and the second holding part as seen from axis directions of the rotation axis.

With this configuration, the moment applied to the end effector may be made smaller.

In the robot according to the aspect of the invention, it is preferable that the force detection unit is a load cell.

The load cell is generally small and, when the force detection unit is the load cell, the robot may be easily downsized.

### BRIEF DESCRIPTION OF THE DRAWINGS

The invention will be described with reference to the accompanying drawings, wherein like numbers reference like elements.

FIG. 1 is a side view of a robot according to a preferred embodiment of the invention.

FIG. 2 is a perspective view showing a coupling component and a tool of the robot shown in FIG. 1.

FIG. 3 is a perspective view showing the coupling component and the tool of the robot shown in FIG. 1.

FIG. 4 is a front view showing the coupling component and the tool of the robot shown in FIG. 1.

FIG. 5 is a side view showing the coupling component and the tool of the robot shown in FIG. 1.

### DESCRIPTION OF EXEMPLARY EMBODIMENTS

As below, a robot system including a robot according to the invention will be explained in detail based on embodiments shown in the accompanying drawings.

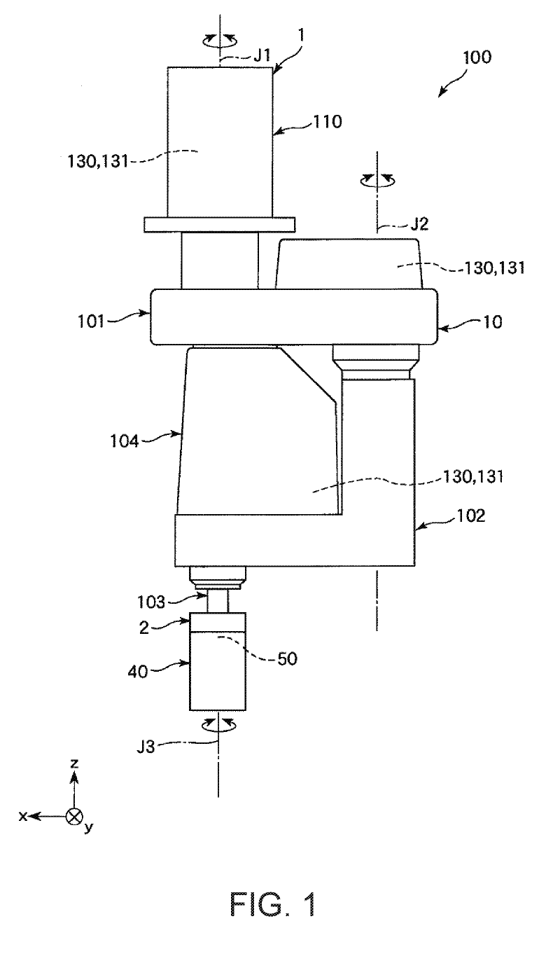

FIG. 1 is a side view of a robot according to a preferred embodiment of the invention. Hereinafter, for convenience of explanation, the upside in FIG. 1 is referred to as “upper” and the downside is referred to as “lower”. The base 110 side in FIG. 1 is referred to as “proximal end” and the opposite side (i.e., the end effector (tool 40) side) is referred to as “distal end”. Further, in FIG. 1, for convenience of explanation, as three axes orthogonal to one another, an x-axis, a y-axis, and a z-axis are shown. Hereinafter, directions parallel to the x-axis are also referred to as “x-axis directions”, directions parallel to the y-axis are also referred to as “y-axis directions”, and directions parallel to the z-axis are also referred to as “z-axis directions”. Further, hereinafter, the distal end side of each arrow shown in the drawings is referred to as “+ (plus)” and the proximal end side is referred to as “− (minus)”. The upward and downward directions in FIG. 1 are referred to as “vertical directions” and the leftward and rightward directions are referred to as “horizontal directions”. In the specification, “horizontal” includes tilts within a range of ±5° or less with respect to the horizontal. Similarly, “vertical” includes tilts within a range of ±5° or less with respect to the vertical. Further, “parallel” includes not only the case where two lines (including axes) or surfaces are completely parallel to each other but also the case with tilts within ±5° or less. Furthermore, in the specification, “orthogonal” includes not only the case where two lines (including axes) or surfaces cross at an angle of 90° with each other but also the case with tilts within ±5° or less with respect to 90°.

A robot system 100 shown in FIG. 1 is e.g. a system used for work including holding, carrying, assembly of objects such as electronic components and electronic apparatuses.

The robot system 100 includes a robot 1 having a robot arm 10, a tool 40 that directly performs work on an object, a force detection unit 50 that detects e.g. a force applied to the tool 40, and a control apparatus (not shown) that controls driving of the robot 1. As below, the respective parts of the robot system 100 will be explained.

The robot 1 in FIG. 1 is the so-called horizontal articulated robot (scalar robot), and has abase 110, the robot arm 10 (movable part) connected to the base 110, and a coupling component 2 that couples the tool 40 to the robot arm 10. Further, the robot arm 10 has a first arm 101 (arm), a second arm 102 (arm), a workhead 104, and a spline shaft 103. Furthermore, the robot 1 has a plurality of drive units 130 that generate power for driving the robot arm 10 and a plurality of position sensors 131.

The base 110 shown in FIG. 1 is a part for attaching the robot 1 to e.g. a ceiling (not shown). The first arm 101 rotatable about a first axis J1 (rotation axis) along the vertical directions with respect to the base 110 is coupled to the lower end portion of the base 110. Further, the second arm 102 rotatable about a second axis J2 (rotation axis) along the vertical directions with respect to the first arm 101 is coupled to the distal end portion of the first arm 101. The workhead 104 is placed on the second arm 102. The workhead 104 has the spline shaft 103 (arm) inserted into a spline nut and a ball screw nut (both not shown) coaxially placed in the distal end portion of the second arm 102. The spline shaft 103 is rotatable about an axis J3 (rotation axis) thereof and movable in the upward and downward directions (can rise and fall) with respect to the second arm 102.

The coupling component 2, the tool 40 (end effector), and the force detection unit 50 are provided in the distal end portion (lower end portion) of the spline shaft 103. Note that the members provided in the distal end portion (lower end portion) of the spline shaft 103 will be described later in detail.

The drive unit 130 that drives (rotates) the first arm 101 is placed within the base 110. Further, the drive unit 130 that drives the second arm 102 is provided within the first arm 101, and the drive unit 130 that drives the spline shaft 103 is provided within the workhead 104. That is, the robot 1 has the three drive units 130. The drive unit 130 has a motor (not shown) that generates drive power and a reducer (not shown) that reduces the drive power of the motor. As the motor of the drive unit 130, e.g. a servo motor such as an AC servomotor or DC servomotor may be used. As the reducer, e.g. a planetary-gear reducer, strain wave gearing, or the like may be used. The position sensors 131 (angle sensors) that detect the rotation angles of the rotation shafts of the motors or reducers are provided in the respective drive units 130.

The respective drive units 130 are electrically connected to motor drivers (not shown) provided in the base 110. The respective drive units 130 are controlled by the control apparatus (not shown) via the motor drivers. The control apparatus may have any configuration that can control driving of the robot 1 in the above described manner. For example, the control apparatus may include a personal computer (PC) containing a CPU (Central Processing Unit), ROM (Read Only Memory), and RAM (Random Access Memory) or the like. Further, the control apparatus is electrically connected to the above described tool 40 and force detection unit 50 and has a function of controlling driving of the tool 40 and the force detection unit 50.

As above, the basic configuration of the robot system 100 is briefly explained. Next, the coupling component 2, the tool 40 (end effector), and the force detection unit 50 of the robot 1 will be described in detail.

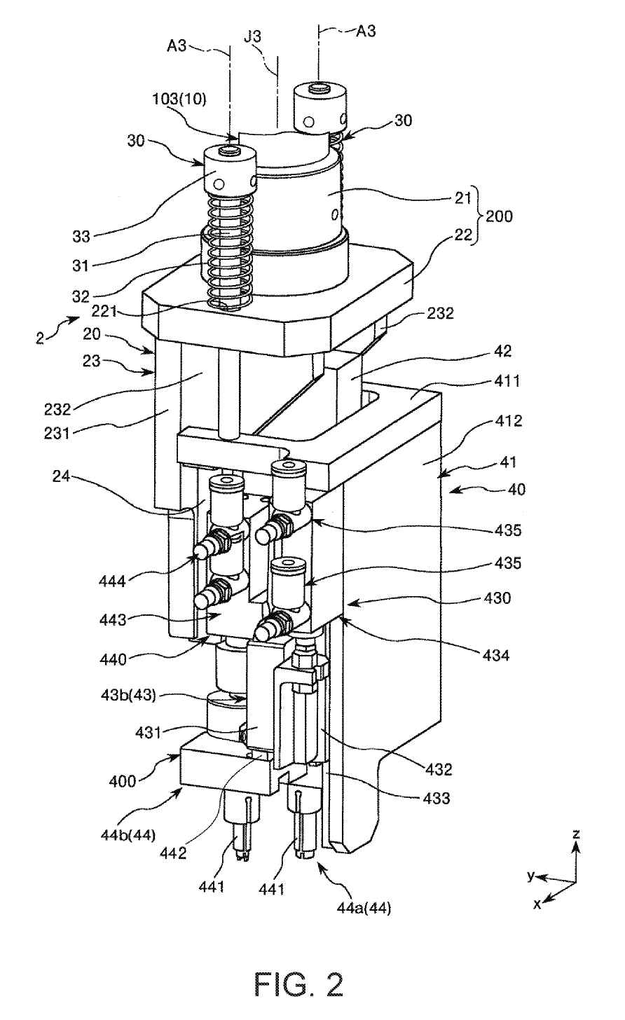

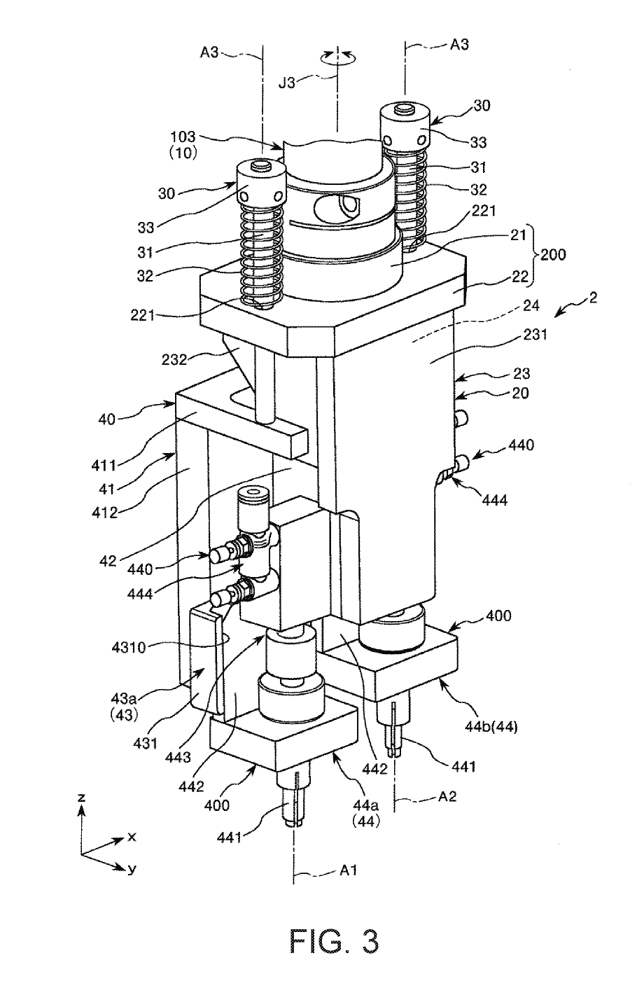

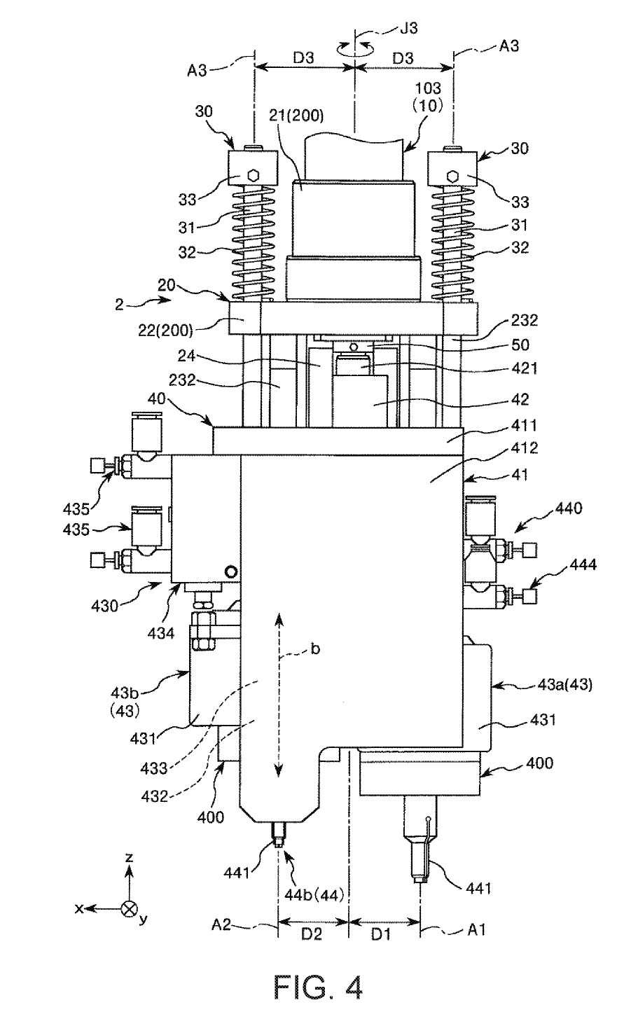

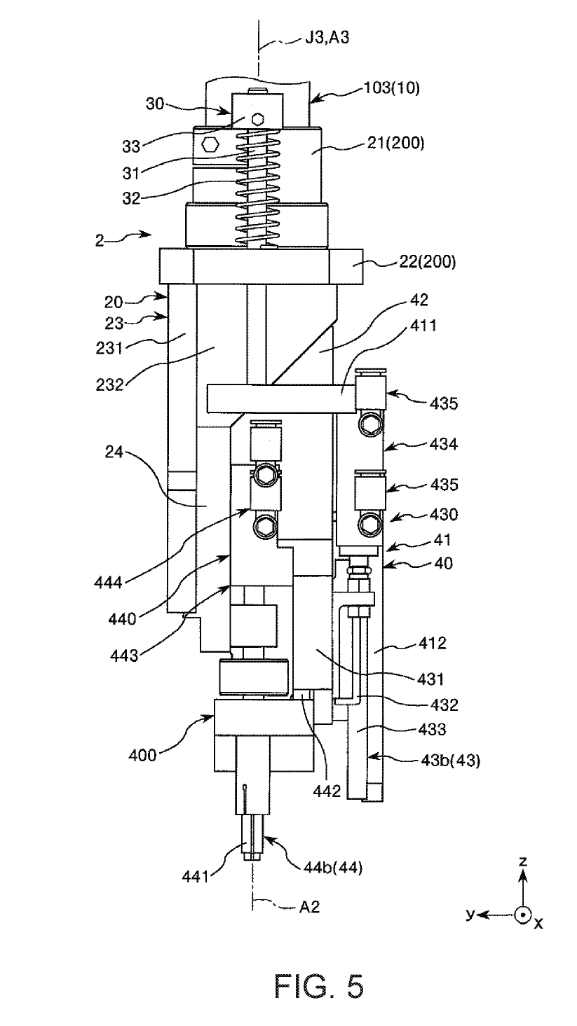

FIGS. 2 and 3 are respectively perspective views showing the coupling component and the tool of the robot shown in FIG. 1. FIG. 4 is a front view showing the coupling component and the tool of the robot shown in FIG. 1. FIG. 5 is a side view showing the coupling component and the tool of the robot shown in FIG. 1.

### Coupling Component

The coupling component 2 shown in FIGS. 2 to 5 is a member that couples the drive unit 130 and the tool 40, and has a coupling part 20 and two (a pair of) energizing parts 30.

### Coupling Part

The coupling part 20 has a cylindrical first connecting member 21, a second connecting member 22 in a flat plate shape located in the lower end portion of the first connecting member 21 and having a plate surface parallel to the xy-plane, a supporting member 23 located in the lower end portion of the second connecting member 22, and a guide member 24 connected (fixed) to the supporting member 23 (see FIGS. 2 to 5). Here, the first connecting member 21 and the second connecting member 22 form a connecting part 200.

The first connecting member 21 is formed so that the distal end portion of the spline shaft 103 may be inserted into the cylinder. The distal end portion of the spline shaft 103 is inserted and fitted into the first connecting member 21, and the coupling part 20 and the robot arm 10 are connected. Thereby, the coupling part 20 is rotatable about the axis J3 with the rotation of the spline shaft 103. Further, the second connecting member 22 is connected (fixed) to the lower end portion of the first connecting member 21. The first connecting member 21 is located in the center part of the second connecting member 22 as seen from the z-axis directions (the axis directions of the axis J3). Furthermore, two through holes 221 are provided around the first connecting member 21 with the first connecting member 21 in between. Into the through holes 221, shafts 31 of the energizing parts 30 to be described later are inserted.

The supporting member 23 is connected (fixed) to the lower end portion of the second connecting member 22. The supporting member 23 has a member 231 in a flat plate shape located in the edge portion on the +y-axis side of the second connecting member 22 and extending in the z-axis directions, and two members 232 in flat plate shapes connected (fixed) to the member 231 and located on the +x-axis side and the −x-axis side of the second connecting member 22. The guide member 24 is provided within a space surrounded by these members 231 and two members 232 (see FIGS. 2 and 4). The guide member 24 is connected (fixed) to the member 231, and has a function of guiding a rail member 42 of the tool 40 to be described later to slide in the z-axis directions. Note that the configuration (mechanism) of the guide member 24 may be any configuration that may guide the rail member 42 of the tool 40. Further, the rail member 42 includes a rail and an attachment member for attaching the rail (not shown).

The constituent materials of the respective parts forming the coupling part 20 are not particularly limited, but e.g. metal materials, resin materials, or the like may be used.

### Energizing Parts

The two energizing parts 30 respectively have the shafts 31, coil springs 32 (energizing members), and nuts 33. In the embodiment, the two energizing parts 30 are placed around the spline shaft 103 (axis J3) to face each other with the spline shaft 103 (axis J3) in between. Note that, in the embodiment, the number of energizing parts 30 is two, but may be one, three, or more.

The shafts 31 have elongated shapes extending in the z-axis directions and are inserted into the through holes 221 of the above described second connecting member 22. The shafts may move (slide) in the z-axis directions (in the longitudinal directions of the shafts 31) within the through holes 221. The lower ends of the shafts 31 are connected (fixed) to a base part 41 of the tool 40 to be described later. Further, male screws for screwing the shafts 31 into the nuts 33 together are formed in the outer circumference surfaces of the upper end portions of the shafts 31.

The coil springs 32 that may expand and contract in the z-axis directions (directions of center lines A3 of the shafts 31) are placed around the outer circumferences of the shafts 31. The coil springs 32 are elastic members having elasticity and located above the second connecting member 22. Particularly, in the embodiment, the coil springs 32 function as compression springs. The coil springs 32 are compressed between the nuts 33 screwed in the upper portions of the shafts 31 and the second connecting member 22 with the shafts 31 inserted therein for energization to separate the nuts 33 from the second connecting member 22. Thereby, the coil springs 32 energize the tool 40 connected (fixed) to the lower end portions of the shafts 31 to be closer to the second connecting member 22.

Further, female screws are formed in the inner circumference surfaces of the nuts 33 and the upper portions of the shafts 31 are screwed into the nuts 33. The positions (positions in the z-axis directions) of the nuts 33 on the shafts 31 are adjustable. Thereby, the energizing forces of the coil springs 32 may be adjusted.

According to the energizing parts 30 of the coupling component 2 having the above described configuration, the tool 40 is suspended with respect to the second connecting member 22. Further, the movements of the tool 40 in the x-axis directions and y-axis directions are restricted by the guide member 24 of the above described coupling part 20 so that the tool may be movable in the z-axis directions.

Note that the tool 40 may be detached from the second connecting member 22 by detachment of the nuts 33 of the energizing parts 30 from the shafts 31. Accordingly, the tool 40 is detachable from the coupling component 2. Therefore, the tool 40 is detachable from the robot arm 10 via the coupling component 2.

The constituent materials of the respective parts forming the energizing parts 30 are not particularly limited, but e.g. metal materials, resin materials, or the like may be used.

### Tool

The tool 40 is an end effector that directly performs work on an object. The tool 40 has the base part 41, the rail member 42, two hand holding parts 43 (first hand holding part 43a, second hand holding part 43b), and two hand parts 44 (first hand part 44a, second hand part 44b). Further, the tool 40 is connected to the coupling component 2 to be rotatable about the axis J3 with the rotation of the spline shaft 103.

### Base Part

The base part 41 has a member 411 connected to the above described shafts 31, and a member 412 (main body portion) in a flat plate shape connected (fixed) to the lower end portion of the member 411 and extending in the z-axis directions. The member 411 has a portion extending in the x-axis directions and two portions extending from both ends of the portion in the +y-axis direction. The above described shafts 31 are connected (fixed) to the two portions extending in the +y-axis direction.

### Rail Member

The rail member 42 attachable to the above described guide member 24 is connected (fixed) to the surface on the +y-axis side of the member 411 (see FIGS. 2, 4, and 5). In the embodiment, the rail member 42 has a shape extending in the z-axis directions and is provided in the center part of the member 412 in the x-axis directions. Further, the rail member 42 is located on the axis J3 of the spline shaft 103 as seen from the y-axis directions (see FIG. 4). Furthermore, a member 421 (contact member) in contact with the force detection unit 50 to be described later is provided in the upper end portion of the rail member 42.

Note that the respective constituent materials of the base part 41 and the rail member 42 are not particularly limited, but e.g. metal materials, resin materials, or the like may be used.

### Hand Holding Parts

The two hand holding parts 43 are members that hold the hand parts 44, which will be described later, and located on both sides of the rail member 42 as seen from the y-axis directions. Therefore, the two hand holding parts 43 are located on both sides of the axis J3 of the spline shaft 103 as seen from the y-axis directions. Further, the two hand holding parts 43 are respectively connected to the member 412 of the base part 41.

The first hand holding part 43a (hand holding part 43) is fixed to the member 412 of the base part 41, and includes a holding member 431 that holds a plate member 442 of the first hand part 44a, which will be described later. The holding member 431 has a concave portion 4310 opening in the +y-axis direction and the concave portion 4310 opens toward the +z-axis side and the −z-axis side (see FIG. 3).

The second hand holding part 43b (hand holding part 43) includes a holding member 431 that holds a plate member 442 of the second hand part 44b, which will be described later, and a movement mechanism 430 for moving the holding member 431 in the z-axis directions (see FIGS. 2 and 5). The movement mechanism 430 has a rail 432, a guide member 433, an air cylinder 434, and a speed controller 435.

The holding member 431 has the same configuration as the holding member 431 of the above described first hand holding part 43a. Further, the rail 432 is connected (fixed) to the surface on the +y-axis side of the holding member 431. The rail 432 has a shape extending in the z-axis directions. The guide member 433 to which the rail 432 can be attached is connected (fixed) to the member 412 of the above described base part 41. The guide member 433 has a function of guiding the rail 432 to slide in the z-axis directions. Note that the configuration (mechanism) of the guide member 433 may be any configuration that may guide the rail 432. Further, the air cylinder 434 is attached to the member 412 of the base part 41. The air cylinder 434 functions as a drive unit for generating drive power for moving the rail 432 with respect to the guide member 433. The speed controller 435 is attached to the air cylinder 434. The speed controller 435 functions as a flow adjustment unit (drive power adjustment unit) for adjustment of the flow rate of the air (gas) within the air cylinder 434. The above described drive power may be adjusted by the speed controller 435. Note that the above described drive unit is not limited to the the air cylinder 434 as long as the unit may generate drive power. The drive unit may include e.g. various motors or the like.

Note that the respective constituent materials of the holding member 431, the rail 432, and the guide member 433 are not particularly limited, but e.g. metal materials, resin materials, or the like may be used.

### Hand Parts

The two hand parts 44 are respectively held by the hand holding parts 43. That is, the first hand part 44a (first holding part) is held by the first hand holding part 43a and the second hand part 44b (second holding part) is held by the second hand holding part 43b. These first hand part 44a and second hand part 44b are located on both sides of the rail 42 as seen from the y-axis directions. Therefore, the two hand holding parts 43 are located on both sides of the axis J3 of the spline shaft 103 as seen from the y-axis directions.

The first hand part 44a and the second hand part 44b respectively have the same configuration and include units 400 having collet chuck hands 441 that grasp objects and plate members 442, and drive mechanisms 440 for generating drive power to open and close the collet chuck hands 441. The drive mechanisms 440 have air cylinders 443 and speed controllers 444.

The collet chuck hand 441 of the unit 400 has a plurality of fingers and may grasp an obj ect by radially opening and closing these fingers. Further, the plate member 442 of the unit 400 has a plate surface parallel to the xz-plane, and is attached to the above described holding member 431 and held by the hand holding part 43. The air cylinder 443 is attached to the upper portion of the unit 400. The air cylinder 443 functions as a drive unit for generating drive power for opening and closing the collet chuck hand 441. Further, the speed controller 444 is attached to the air cylinder 443. The speed controller 444 functions as a flow adjustment unit (drive power adjustment unit) for adjustment of the flow rate of the air (gas) within the air cylinder 443. The above described drive power may be adjusted by the speed controller 444. Note that the above described drive unit is not limited to the the air cylinder 443 as long as the unit may generate drive power. The drive unit may include e.g. various motors, spring members, or the like.

The hand parts 44 having the above described configurations are detachably attached to the hand holding parts 43. Thereby, hand parts (end effector parts) suitable for the types of objects or the like may be used.

Further, as described above, the holding member 431 of the first hand holding part 43a holding the first hand part 44a is fixed to the base part 41. Accordingly, the first hand part 44a is fixedly connected to the base part 41 via the first hand holding part 43a. On the other hand, as described above, the holding member 431 of the second hand holding part 43b holding the second hand part 44b is movable with respect to the base part 41 by the movement mechanism 430. Therefore, the second hand part 44b is movably connected in directions of an arrow b in FIG. 4 with respect to the base part 41 via the second hand holding part 43b. Thereby, the heights of the distal end of the first hand part 44a and the distal end of the second hand part 44b may be made different. In the embodiment, the position of the distal end of the second hand part 44b may be located above and below the position of the distal end of the first hand part 44a.

Note that the respective constituent materials of the collet chuck hands 441 and the plate members 442 are not particularly limited, but e.g. metal materials, resin materials, or the like may be used.

### Force Detection Unit

As shown in FIG. 4, the force detection unit 50 is attached to the lower surface (lower end portion) of the above described second connecting member 22. The force detection unit 50 has a function of detecting e.g. a force applied to the tool 40, more specifically, forces (external forces) applied to the collet chuck hands 441. In the embodiment, the force detection unit 50 includes a load cell. The load cell (not shown) includes e.g. a strain body (elastic body) in which strain is generated by a force, a strain gauge that detects the force as an electrical signal based on an amount of strain (amount of displacement) from the strain body, and a case housing the strain body and the strain gauge. In the embodiment, the load cell may detect forces in the z-axis directions applied to the tool 40. Accordingly, the contact of the collet chuck hands 441 with an object or the like may be sensed, and additionally, e.g. weights of objects grasped by the collet chuck hands 441 may be detected.

The forces that may be detected by the force detection unit 50 include not only the forces in the z-axis directions but also e.g. forces in the x-axis directions, forces in the y-axis directions, torque about the x-axis, torque about the y-axis, torque about the z-axis (e.g. axis J3), and combinations of two or more of the forces. Further, assuming that another coordinate system than that described above, e.g. the coordinate system of the robot 1 (the coordinate system of the tool 40) has an x′-axis, a y′-axis, a z′-axis (not shown), the forces include forces in the x′-axis directions, forces in the y′-axis directions, forces in the z′-axis directions, torque about the x′-axis, torque about the y′-axis, torque about the z′-axis, and combinations of two or more of the forces.

The constituent material of the case housing the strain gauge is not particularly limited, but e.g. a metal material, resin material, or the like may be used. In the embodiment, “force detection unit” is not limited to the load cell as long as the unit may detect an external force. For example, “force detection unit” may be a force sensor or the like.

Further, in the embodiment, an energizing force acts in a direction in which the tool 40 and the second connecting member 22 are closer to each other by the coil springs 32 of the above described energizing parts 30. Thereby, the force detection unit 50 attached to the lower surface of the second connecting member 22 is in contact with the member 421 (contact member) provided in the upper end portion of the rail member 42 of the tool 40 in a state in which the collet chuck hands 441 are not in contact with an object or the like (non-contact state).

As above, the respective configurations of the coupling component 2, the tool 40 (end effector), and the force detection unit 50 provided in the distal end portion (lower end portion) of the spline shaft 103 are explained.

As described above, the robot 1 of the embodiment has the spline shaft 103 as at least one “arm”, and includes the robot arm 10 from which the tool 40 as “end effector” is detachable, the force detection unit 50 provided between the tool 40 and the spline shaft 103, and the coil springs 32 as “energizing members” that energize the tool 40 toward the force detection unit 50 side. According to the robot 1, the energizing parts 30 having the coil springs 32 that energize the tool 40 toward the force detection unit 50 side are provided, and thereby, rattles (play, backlash) or the like of the tool 40 may be reduced. Accordingly, detection accuracy of the contact of the collet chuck hands 441 of the tool 40 with an object or the like by the force detection unit 50 may be improved.

Note that, in the embodiment, the tool 40 having the collet chuck hands 441 is used as “end effector”, however, “end effector” is not limited to the tool 40 having the collet chuck hands 441 as long as the end effector directly perform work on an object. For example, “end effector” may have a suction mechanism that suctions and holds an object. Further, “end effector” refers to a part that directly perform work on an object and the attachment location thereof is not limited to the distal end of the robot arm 10.

In the embodiment, the force detection unit 50 is provided between the spline shaft 103 and the tool 40, however, maybe provided in any location between the arm (first arm 101, second arm 102 or spline shaft 103) of the robot arm 10 and the end effector (tool 40).

Note that, as described above, in the embodiment, the connecting part 200 coupling the robot arm 10 and the tool 40 as “end effector” is provided and the force detection unit 50 is provided between the tool 40 and the connecting part 200. Thereby, the detection accuracy of the contact of the collet chuck hands 441 of the tool 40 with an object or the like by the force detection unit 50 may be particularly improved.

Further, as described above, in the embodiment, the energizing forces of the coil springs 32 are adjusted by the nuts 33, and thereby, the force detection unit 50 is brought into contact with the member 421 (contact member) of the tool 40 in the state in which the collet chuck hands 441 are not in contact with an object or the like (non-contact state). Here, for example, if the member 421 of the tool 40 is not in contact with the force detection unit 50 in the non-contact state, when the collet chuck hands 441 come into contact with an object or the like, a time lag is caused before the contact of the member 421 with the force detection unit 50. Further, when the member 421 of the tool 40 is not in contact with the force detection unit 50, the above described time lag increases due to an inertial force by the weight of the tool 40. Accordingly, linearity (responsiveness) of the reaction by the force detection unit 50 is lower. However, in the embodiment, as described above, the force detection unit 50 is brought into contact with the member 421 of the tool 40 in the non-contact state by the energizing parts 30. Accordingly, the linearly of the reaction by the force detection unit 50 may be made higher.

As described above, in the embodiment, “energizing members” are the coil springs 32 (elastic members) having elasticity. Thereby, application of an excessive force from the member 421 to the force detection unit 50 in the non-contact state may be reduced or avoided. For example, even when an external force from a direction within the xy-plane is applied to the tool 40 with driving of the spline shaft 103, application of an excessive force from the member 421 to the force detection unit 50 may be reduced or avoided. As described above, the coil springs 32 are used, and thereby, rattles (play, backlash) or the like of the tool 40 may be reduced more effectively. As a result, the detection accuracy of the force detection unit 50 may be further improved. Note that, in the embodiment, the coil springs 32 are used as the elastic members, however, the elastic members are not limited to the coil springs 32 as long as the members have elasticity. For example, elastic members having functions as extension springs may be used. In this case, elastic members having functions as extension springs may be provided between the second connecting member 22 and the member 421 of the tool 40.

Further, as described above, the spline shaft 103 as “arm” is rotatable, the tool 40 as “end effector” is rotatable about the axis J3 as “rotation axis” of the spline shaft 103, and the plurality (two) of the coil springs 32 as “energizing members” are provided around the axis J3. Thereby, the tool 40 may be energized toward the force detection unit 50 side with balance, and rattles or the like of the tool 40 may be reduced more effectively. Accordingly, the detection accuracy of the force detection unit 50 may be further improved.

Particularly, in the embodiment, distances D3 between the axis J3 and the center lines A3 of the respective shafts 31 are equal (see FIG. 4). Thereby, the tool 40 may be energized toward the force detection unit 50 side particularly with balance. Note that the above described “distances D3 are equal” includes errors in mechanical design and installation.

In the embodiment, as described above, the force detection unit 50 is the load cell. The load cell is generally small and, when the force detection unit 50 is the load cell, the structure including the coupling component 2, the tool 40, and the force detection unit 50 may be easily downsized. Further, when the force detection unit 50 is the load cell, the force detection unit 50 is kept in contact with the member 421 of the tool 40, and thereby, the effect of improving the detection accuracy of the force detection unit 50 may be exerted more remarkably.

The tool 40 as “end effector” has the first hand part 44a as “first holding part” and the second hand part 44b as “second holding part” that can hold objects. Thereby, for example, two objects may be grasped at a time by the tool 40. Accordingly, workability by the robot 1 may be improved. Further, one object may be grasped at two points and the hold may be more reliable and drop or the like may be effectively prevented. Note that, in the embodiment, the number of hand parts 44 is two, however, may be one, three, or more.

As described above, the tool 40 as “end effector” has the base part 41, and the first hand part 44a as “first holding part” is fixed to the base part 41 via the first hand holding part 43a and the second hand part 44b as “second holding part” is movable with respect to the base part 41 via the second hand holding part 43b. Thereby, the heights (the positions in the z-axis directions) of the distal end portions of the first hand part 44a and the second hand part 44b may be made different. Accordingly, for example, after the distal end of the second hand part 44b is located below the distal end of the first hand part 44a and an object is grasped by the second hand part 44b, the distal end of the second hand part 44b is located above the distal end of the first hand part 44a, and then, an object may be grasped by the first hand part 44a. In this manner, interferences between the object held by the first hand part 44a and the object held by the second hand part 44b may be reduced more effectively. Particularly, as will be described later, even when offsets of the hand parts 44 from the axis J3 (specifically, the distances D1, D2) are set to smaller values, the above described effect may be effectively exerted. The first hand part 44a is fixed, and thereby, the moment about the axis J3 applied to the tool 40 may be made relatively small. Accordingly, rattles or the like of the tool 40 may be further reduced and the detection accuracy of the force detection unit 50 may be further improved. Moreover, the first hand part 44a is fixed, and only the movement mechanism 430 for the second hand part 44b (particularly, the air cylinder 434) may be provided and the movement mechanism for the first hand part 44a may be omitted. Thereby, the size and weight of the tool 40 may be reduced and the moment about the axis J3 applied to the tool 40 may be made smaller.

In other words, in the robot 1 of the embodiment, the second hand part 44b as “second holding part” can move over a longer distance than the first hand part 44a as “first holding part”. Thereby, interferences between the object held by the first hand part 44a and the object held by the second hand part 44b may be reduced.

Note that, in the embodiment, the first hand part 44a is fixed with respect to the base part 41 (the distance that the part can move is zero), however, the first hand part 44a may be movable like the second hand part 44b. In this case, as described above, the first hand part 44a can move over a shorter distance than the second hand part 44b, and interferences between the objects may be easily reduced or avoided.

The spline shaft 103 as “arm” is rotatable, the tool 40 as “end effector” is rotatable about the axis J3 as “rotation axis” of the spline shaft 103, and the first hand part 44a as “first holding part” and the second hand part 44b as “second holding part” are provided so that the axis J3 may be located between the first hand part 44a and the second hand part 44b as seen from the axis directions of the axis J3 (as seen from the z-axis directions). Thereby, the moment applied to the tool 40 may be made smaller. Particularly, in the embodiment, the axis J3, the center line A1 of the collet chuck hand 441 of the first hand part 44a, and the center line A2 of the collet chuck hand 441 of the second hand part 44b are located in a straight line as seen from the z-axis directions. Thereby, the moment applied to the tool 40 may be made particularly smaller.

Further, the spline shaft 103 as “arm” is rotatable, the tool 40 as “end effector” is rotatable about the axis J3 as “rotation axis” of the spline shaft 103, the first hand part 44a as “first holding part” and the second hand part 44b as “second holding part” are respectively provided around the axis J3, and, letting the distance between the center of the first hand part 44a (specifically, the center line A1) and the axis J3 be D1 and the distance between the center of the second hand part 44b (specifically, the center line A2) and the axis J3 be D2, it is preferable that 0.9≤D1/D2≤1.1 and more preferable that 0.95≤D1/D2≤1.05 (see FIG. 4). Particularly, in the embodiment, the distance D1 and the distance D2 are equal. Thereby, the moment about the axis J3 applied to the tool 40 as the end effector may be made smaller. Note that “the distance D1 and the distance D2 are equal” includes errors in mechanical design and installation. Further, the distance D1 and the distance D2 may be respectively set to relatively small values, e.g. from 15 to 50 mm, particularly, from 18 to 35 mm. Thereby, the above described effects may be exerted more remarkably.

As above, the robot according to the invention is explained with reference to the illustrated embodiment, however, the invention is not limited to that. The configurations of the respective parts may be replaced by arbitrary configurations having the same functions. Further, other arbitrary configurations may be added to the invention.

In the above described embodiment, the case where the robot is installed on the ceiling is explained as the example, however, the installation location of the robot is arbitrary, not limited to that. The robot may be provided on e.g. a worktable, ground, wall, movable platform, or the like.

In the above described embodiment, the so-called horizontal articulated robot is explained, however, the robot according to the invention is not limited to that as long as the robot has the energizing member and the force detection unit and may be applied to e.g. a vertical articulated robot.

The entire disclosure of Japanese Patent Application No. 2017-007316, filed Jan. 19, 2017 is expressly incorporated by reference herein.

What is claimed is:

1. A robot comprising:
a robot arm having at least one arm, from which an end effector is detachable;
a force detection unit provided between the end effector and the arm; and
an energizing member that energizes the end effector toward the force detection unit side.

2. The robot according to claim 1, wherein the energizing member is an elastic member having elasticity.

3. The robot according to claim 1, further comprising a connecting part that couples the robot arm and the end effector,
wherein the force detection unit is provided between the end effector and the connecting part.

4. The robot according to claim 1, wherein the arm is rotatable,
the end effector is rotatable about a rotation axis of the arm, and
a plurality of the energizing members are provided around the rotation axis.

5. The robot according to claim 1, wherein the end effector has a first holding part and a second holding part that can hold an object.

6. The robot according to claim 5, wherein the second holding part can move over a longer distance than the first holding part.

7. The robot according to claim 5, wherein the end effector has a base part,
the first holding part is fixed to the base part, and
the second holding part is movable with respect to the base part.

8. The robot according to claim 5, wherein the arm is rotatable,
the end effector is rotatable about a rotation axis of the arm,
the first holding part and the second holding part are respectively provided around the rotation axis, and
letting a distance between a center of the first holding part and the rotation axis be D1 and a distance between a center of the second holding part and the rotation axis be D2, 0.9≤D1/D2≤1.1.

9. The robot according to claim 5, wherein the arm is rotatable,
the end effector is rotatable about a rotation axis of the arm, and
the first holding part and the second holding part are provided so that the rotation axis may be located between the first holding part and the second holding part as seen from axis directions of the rotation axis.

10. The robot according to claim 1, wherein the force detection unit is a load cell.
